(19) United States
(12) Patent Application Publication
(10) Pub. No.: US 2025/0054669 A1
(43) Pub. Date: Feb. 13, 2025

(54) FASTENER HANDLING TOOLS AND METHODS OF HANDLING FASTENERS

(71) Applicant: Toyota Motor Engineering & Manufacturing North America, Inc., Plano, TX (US)

(72) Inventors: Lloyd R. Holland, Georgetown, KY (US); Scottie L. Foster, Lawrenceburg, KY (US); Bradley J. Garcia, Louisville, KY (US); Michael C. Greenlee, Paris, KY (US); Jeffrey L. James, Mount Sterling, KY (US); Jason E. Anderson, Lexington, KY (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/231,573

(22) Filed: Aug. 8, 2023

(51) Int. Cl. H01F 7/02

(52) U.S. Cl. CPC H01F 7/0257

(57) ABSTRACT

A method of picking a predetermined number of fasteners is provided. The method includes placing a fastener handling tool adjacent the predetermined number of fasteners. The fastener handling tool includes a body that includes a holding side, a picking side opposite the holding side, a front wall, a rear wall opposite the front wall and opposite side walls that extend between the holding side and the picking side. The body includes an elongated slot on the picking side that extends between the opposite side walls along a width of the body and an elongated hole on the picking side that is offset from the elongated slot. The elongated slot and the elongated hole extend parallel between the opposite sidewalls providing a gap between the elongated slot and the elongated hole. A magnet is located at the elongated hole. The predetermined number of fasteners are attracted to an edge of the elongated slot using the magnet located at the elongated hole.

### TECHNICAL FIELD

The present specification generally relates to fastener handling tools, and more specifically, fastener handling tools that can be used to handle a predetermined number of fasteners.

### BACKGROUND

Mechanical fasteners, such as nails, rivets, etc. are often picked by hand and then used to fasten materials together. There may be times when it is more efficient to pick up multiple fasteners at once and carry them to a location where they are used. However, it can be difficult to gather a predetermined number of fasteners manually. Also, fasteners may be dropped during this picking process placing parts on the floor and creating a cleanliness issue.

What is needed are tools that help in handling fasteners.

### SUMMARY

In one embodiment, a method of picking a predetermined number of fasteners is provided. The method includes placing a fastener handling tool adjacent the predetermined number of fasteners. The fastener handling tool includes a body that includes a holding side, a picking side opposite the holding side, a front wall, a rear wall opposite the front wall and opposite side walls that extend between the holding side and the picking side. The body includes an elongated slot on the picking side that extends between the opposite side walls along a width of the body and an elongated hole on the picking side that is offset from the elongated slot. The elongated slot and the elongated hole extend parallel between the opposite sidewalls providing a gap between the elongated slot and the elongated hole. A magnet is located at the elongated hole. The predetermined number of fasteners are attracted to an edge of the elongated slot using the magnet located at the elongated hole.

In another embodiment, a fastener handling tool includes a body that includes a holding side, a picking side opposite the holding side, a front wall, a rear wall opposite the front wall and opposite side walls that extend between the holding side and the picking side. The body includes an elongated slot on the picking side that extends between the opposite side walls along a width of the body and an elongated hole on the picking side that is offset from the elongated slot. The elongated slot and the elongated hole extend parallel between the opposite sidewalls providing a gap between the elongated slot and the elongated hole. A magnet is located in the elongated hole.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 illustrates a diagrammatic view of a fastener handling tool for picking a predetermined number of fasteners, according to one or more embodiments shown and described herein;

FIG. 2 illustrates a diagrammatic view of the fastener handling tool in use, according to one or more embodiments shown and described herein; and

FIG. 3 illustrates a diagrammatic view of the fastener handling tool in use, according to one or more embodiments shown and described herein.

### DETAILED DESCRIPTION

Embodiments described herein are directed to fastener handling tools and methods of picking a predetermined number of fasteners. The method includes placing a fastener handling tool adjacent a row of fasteners. The fastener handling tool includes a body that includes a holding side, a picking side opposite the holding side, a front wall, a rear wall opposite the front wall and opposite side walls that extend between the holding side and the picking side. The body includes an elongated slot on the picking side that extends between the opposite side walls along a width of the body and an elongated hole on the picking side that is offset from the elongated slot. The elongated slot and the elongated hole extend parallel between the opposite sidewalls providing a gap between the elongated slot and the elongated hole. A magnet is located at the elongated hole and the fasteners are attracted to an edge of the elongated slot using the magnet located at the elongated hole.

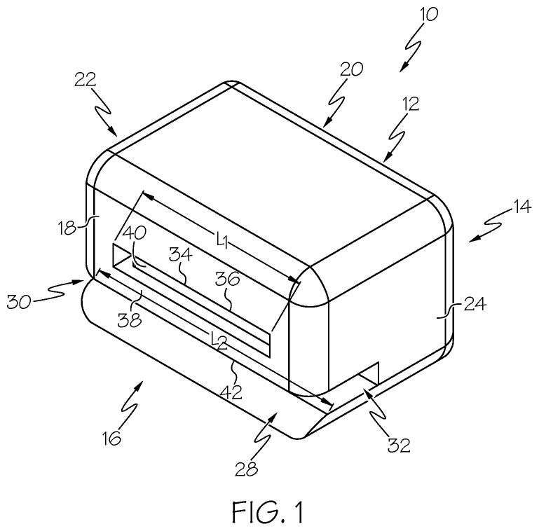

Referring to FIG. 1, a fastener handling tool 10 includes a body 12 that, in some embodiments, may be box-shaped and have a generally rectangular cross-section that includes a holding side 14, a picking side 16 that faces opposite the holding side 14, a front wall 18, a rear wall 20 that faces opposite the front wall 18 and opposite side walls 22 and 24 that extend between the holding side 14 and the picking side 16. The holding side 14, picking side 16, front wall 18, rear wall 20 and sidewalls 22 and 24 are generally planar over a majority of their exterior surfaces and intersect at curved edges 26. The body 12 may be formed using any suitable method, such as molding or 3D printing.

The body 12 includes an elongated slot 28 on the picking side 16 that extends between the opposite sidewalls 22 and 24. In some embodiments, the elongated slot 28 intersects one or both of the sidewalls 22 and 24 such that the elongated slot 28 has open ends 30 and 32. The body 12 further includes an elongated hole 34 that extends between the opposite sidewalls 22 and 24. The elongated hole 34 may have a closed perimeter edge 36 and may extend parallel to the elongated slot 28 between the sidewalls 22 and 24 providing a gap 38 between the elongated hole 34 and the elongated slot 28. A magnet 40 is located in (e.g., pressed into) the elongated hole 34. The magnet 40 provides a magnetic force that attracts fasteners toward an edge 42 of the elongated slot 28. The elongated hole 34 and magnet 40 have a length L₁ that is less than a length L₂ of the elongated slot 28. The length L₁ is selected to be less than a total length of a row of a preselected number of fasteners.

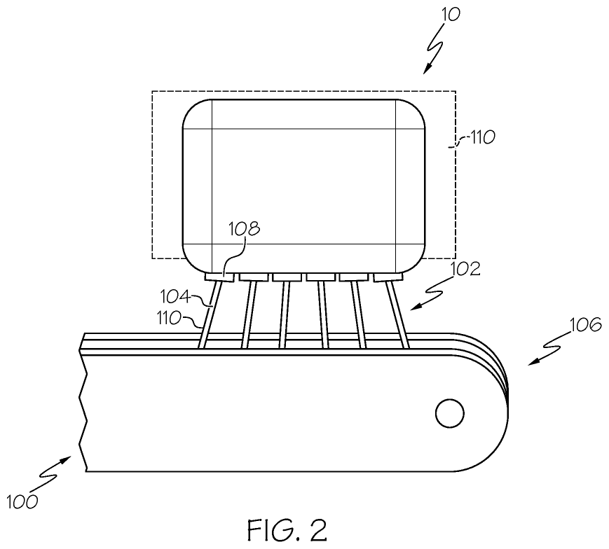

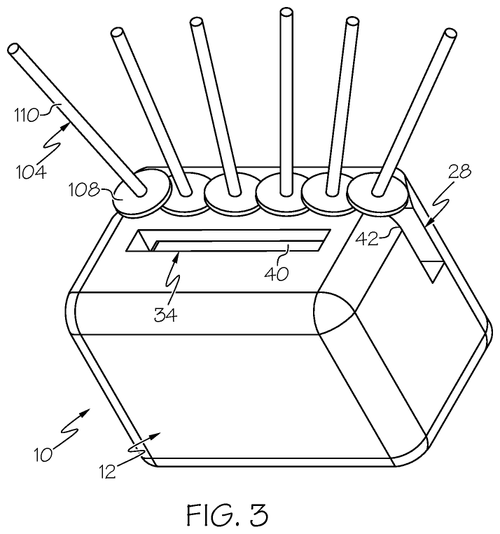

FIGS. 2 and 3 show the fastener handling tool 10 in use. Referring first to FIG. 2, a conveyor system 100 can be used to convey a row 102 of a predetermined number of fasteners 104 (e.g., six fasteners) toward a picking station, generally referenced as element 106. The fasteners 104 may be, for example, rivets having an enlarged head 108 and a smooth cylindrical shaft 110. When the elongated slot 28 is brought into the vicinity of the predetermined number of fasteners 104 the magnet 40 attracts the heads 108 toward the edge 42 of the elongated slot 28. Due to the length L₂ on the predetermined number of fasteners 104 can be captured along the elongated slot 28. In some embodiments, a guide 110 may be used to properly align the slot 28 with the fasteners 104.

Referring to FIG. 3, due to the shorter length L₁ of the elongated hole 34 and the magnet 40, the fasteners 104 are held in a fan pattern with the shafts 110 flared away from one another. Such a flared pattern can make picking each fastener 104 from the fastener handling tool 10 easier.

The above-described fastener handling tool allows picking a predetermined number of fasteners simultaneously in an easy and reliable fashion. The fastener handling tool also fans the shafts of the fasteners for ease of picking the fasteners one-at-a-time and then loaded into a hammer tool, such as a rivet gun. The fastener handling tool can also reduce unintended dropping of the fasteners onto the floor. The fastener handling tool can fit in a palm of a user's hand and be easily manipulated.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue and the tip-receiving bore can provide for accurate alignment with the electrode tip.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of picking a predetermined number of fasteners, the method comprising:
placing a fastener handling tool adjacent the predetermined number of fasteners, the fastener handling tool comprising:
a body that includes a holding side, a picking side opposite the holding side, a front wall, a rear wall opposite the front wall and opposite side walls that extend between the holding side and the picking side, the body including an elongated slot on the picking side that extends between the opposite side walls along a width of the body and an elongated hole on the picking side that is offset from the elongated slot, where the elongated slot and the elongated hole extend parallel between the opposite sidewalls providing a gap between the elongated slot and the elongated hole, and a magnet is located at the elongated hole; and
attracting the predetermined number of fasteners to an edge of the elongated slot using the magnet located at the elongated hole.

2. The method of claim 1 further comprising conveying at least the predetermined number of fasteners in a row to a picking station.

3. The method of claim 1, wherein the elongated slot has a first length and the elongated hole has a second length that is less than the first length.

4. The method of claim 3, wherein the step of attracting the predetermined number of fasteners to the edge of the elongated slot comprises attracting the predetermined number of fasteners with shafts in a fan pattern.

5. The method of claim 1, wherein the fasteners are rivets.

6. The method of claim 1 further comprises guiding the fastener handling tool adjacent the predetermined number of fasteners using a guide.

7. The method of claim 1 further comprising pressing the magnet into the elongated hole.

8. A fastener handling tool comprising:
a body that includes a holding side, a picking side opposite the holding side, a front wall, a rear wall opposite the front wall and opposite side walls that extend between the holding side and the picking side, the body including an elongated slot on the picking side that extends between the opposite side walls along a width of the body and an elongated hole on the picking side that is offset from the elongated slot, the elongated slot and the elongated hole extend parallel between the opposite sidewalls providing a gap between the elongated slot and the elongated hole; and
a magnet is located in the elongated hole.

9. The fastener handling tool of claim 8, wherein the elongated slot has a first length and the elongated hole has a second length that is less than the first length.

10. The fastener handling tool of claim 9, wherein the elongated hole has a closed edge around a perimeter of the elongated hole and the slot has open ends that intersect the opposite side walls.

11. The fastener handling tool of claim 8, wherein the magnet is pressed into the elongated hole.
